(19) United States
(12) Patent Application Publication
(10) Pub. No.: US 2018/0109864 A1
(43) Pub. Date: Apr. 19, 2018

(54) Bluetooth Headphone With Charging and Analog Pass Through Connector

(71) Applicant: Ever Win International Corporation, City of Industry, CA (US)

(72) Inventor: Yasuhiro Yamamoto, Los Angeles, CA (US)

(73) Assignee: Ever Win International Corporation, City of Industry, CA (US)

(21) Appl. No.: 15/297,399

(22) Filed: Oct. 19, 2016

(51) Int. Cl. H04R 1/10; H01R 24/64

(52) U.S. Cl. CPC H04R 1/1025; H04R 1/1016; H01R 24/64; H01R 2107/00; H04R 1/1041; H04R 2420/09; H04R 1/1033; H04R 2420/07

(57) ABSTRACT

A Bluetooth headphone with charging and analog pass through connector is a rechargeable wireless headphone with an integrated charging and analog pass through connector. The rechargeable wireless headphone comprises of a pair of earphones connected to each other by a cable with a charging and analog pass through connector. The cable incorporates a microphone, a power/sync button, a wireless communication module, a rechargeable battery, and a USB Type-C connector for charging the rechargeable battery and also functions as an analog pass through connector.

### BACKGROUND

### Field of Invention

The present invention relates generally to wireless headphones. More specifically, the present invention relates to a rechargeable wireless headphone.

### Description of Related Art

Headphones are commonly used to listen to music and other audio signals. Headphones may use a headband made of metal or polymer to connect the two speakers that fit over and cover each ear. Headphones may also be designed such that they are small and are insertable into the ear canals of the listener, thereby eliminating the need for a headband.

One type of headphone may have a wire that is used to connect the headphone to the signal source, such as a mobile phone. When a headphone is connected with the signal source with a wire, it can receive the necessary power from the signal source to power the speakers through the wire.

Another type of headphone may connect wirelessly with the signal source, such as a mobile phone, through short-range communication standard such as Bluetooth. With a wireless headphone, there is no external power available to the speakers in the wireless headphone and it must rely on a built-in power source. Usually, the built-in power source is a rechargeable battery, such as a rechargeable lithium battery. The rechargeable battery has a limited capacity and once that capacity is exhausted through use of the wireless headphone, the rechargeable battery must be recharged from an external power source.

Most wireless headphones use two types of recharging methods to recharge its rechargeable battery. On method use an external cable or an alternating current (AC) adapter with a cable to connect the wireless headphone to a power source such as a universal serial bus (USB) port on a computer, USB port in a vehicle power adapter, or an AC wall socket to recharge the rechargeable battery. Another method uses proprietary contacts on the wireless headphones to mate with a proprietary charging dongle to recharge the rechargeable battery. Either of these recharging methods requires additional cables and/or charging accessories in addition to the wireless headphone itself to recharge the rechargeable battery.

The additional cable and/or charging accessories must be kept close to the wireless headphone or be carried along with the wireless headphone when traveling. This defeats one of the main advantages of the wireless headphones over the wired headphones. Without the cable and/or charging accessories, once the rechargeable battery's capacity is exhausted, the wireless headphone is rendered useless since the rechargeable battery cannot be recharged without the additional cable and/or charging accessories.

### BRIEF SUMMARY OF THE INVENTION

The Bluetooth headphone with charging and analog pass through connector is a rechargeable wireless headphone with an integrated charging and analog pass through connector. The rechargeable wireless headphone comprises of a pair of earphones connected to each other by a cable with a charging and analog pass through connector. The cable incorporates a microphone, a power/sync button, a wireless communication module, a rechargeable battery in a battery housing, and a USB Type-C connector for charging the rechargeable battery and also functions as an analog pass through connector. In the preferred embodiment, the wireless communication module is a Bluetooth module and uses the Bluetooth wireless communication standard to communicate with the audio signal source.

The rechargeable wireless headphone does not require any additional cable and/or charging accessories to recharge its rechargeable battery. It has a single compact and integrated charging and analog pass through connector that can connect directly to any USB Type-C female port for recharging which eliminates the need for a separate additional cable and/or charging accessories for recharging its rechargeable battery.

### BRIEF DESCRIPTION OF THE DRAWINGS

FIG. 1 shows a perspective view of the preferred embodiment of the Bluetooth headphone with charging and analog pass through connector.

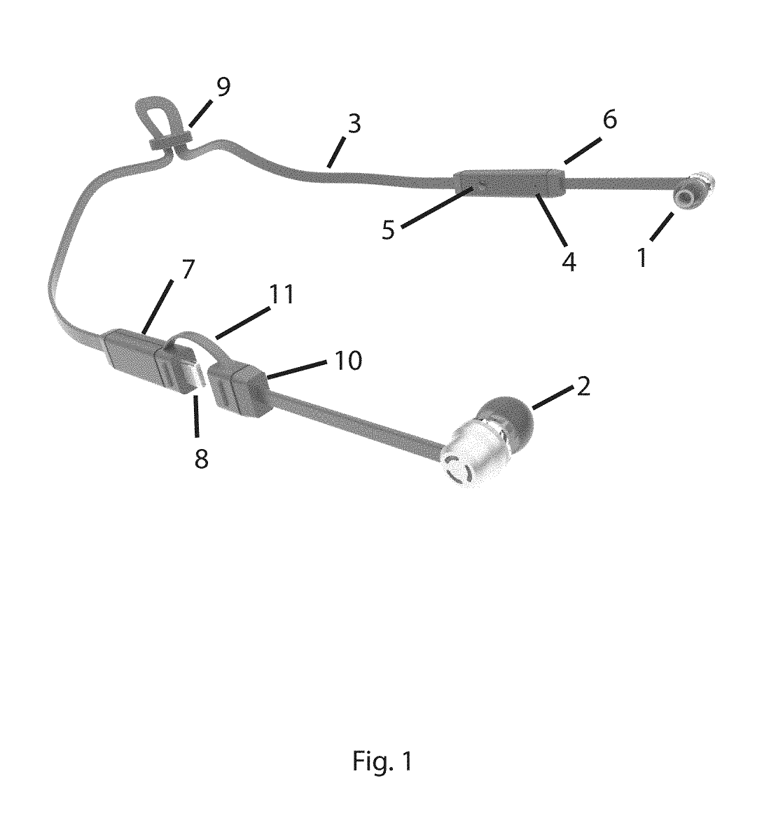

FIG. 2 shows another perspective view of the preferred embodiment of the Bluetooth headphone with charging and analog pass through connector.

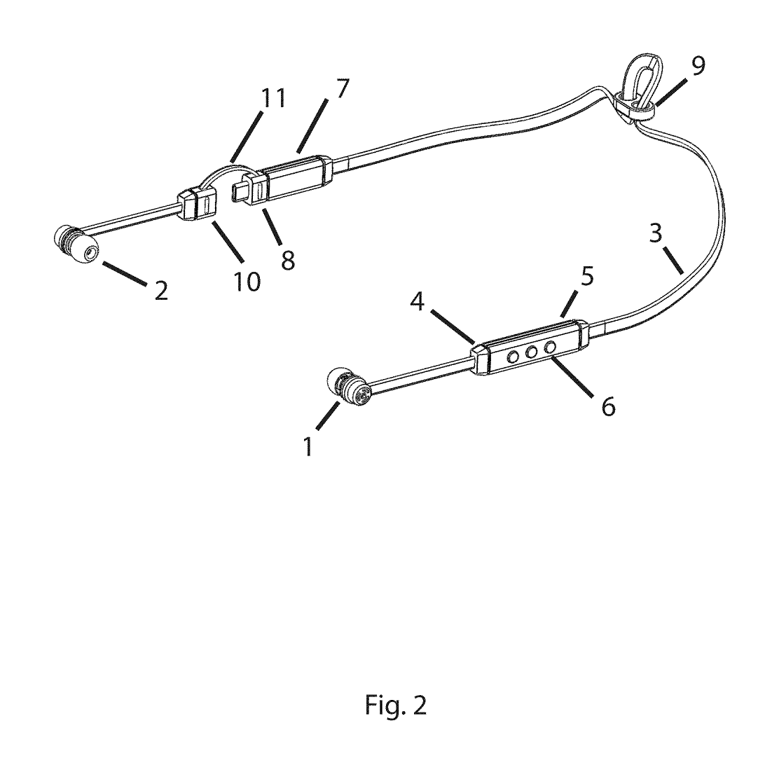

FIG. 3 shows yet another perspective view of the preferred embodiment of the Bluetooth headphone with charging and analog pass through connector.

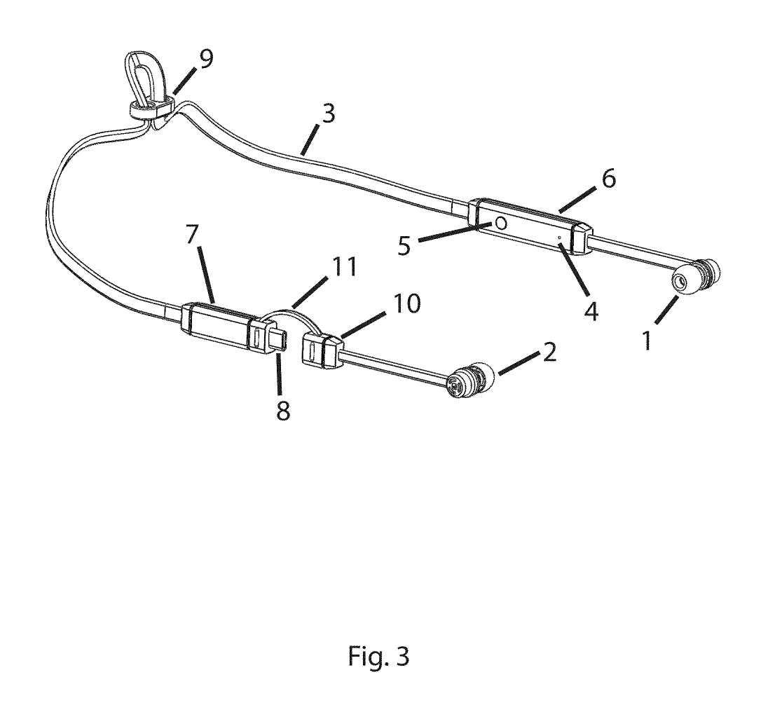

FIG. 4 shows an enlarged perspective view of the USB Type-C connector in the separated position for use as a charging connector.

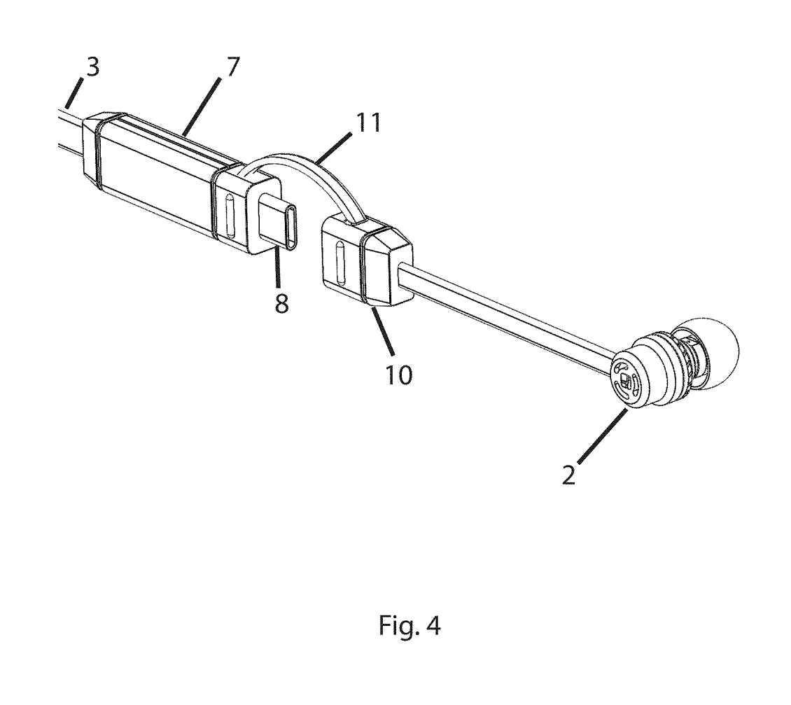

FIG. 5 shows another enlarged perspective view of the USB Type-C connector in the separated position for use as a charging connector.

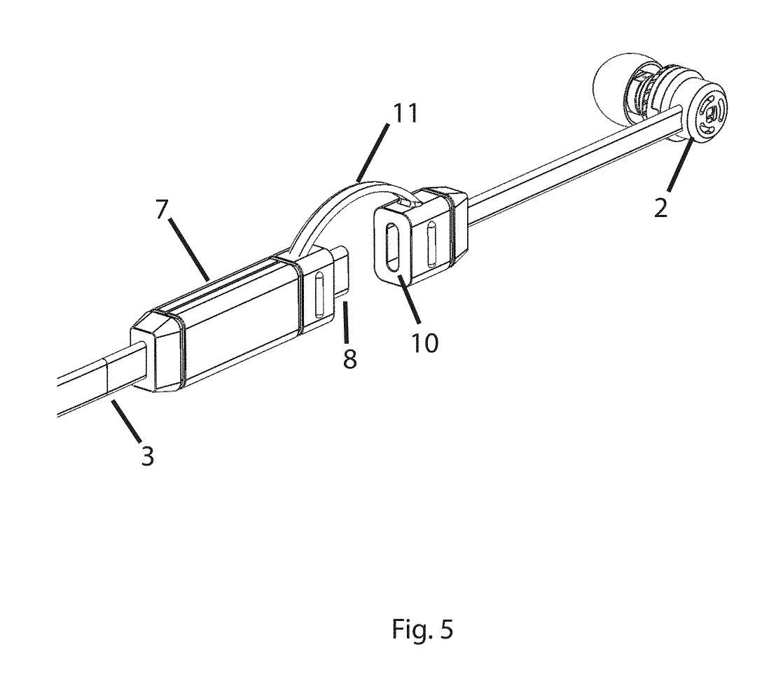

FIG. 6 shows an enlarged perspective view of the USB Type-C connector in the position while functioning as an analog pass through connector.

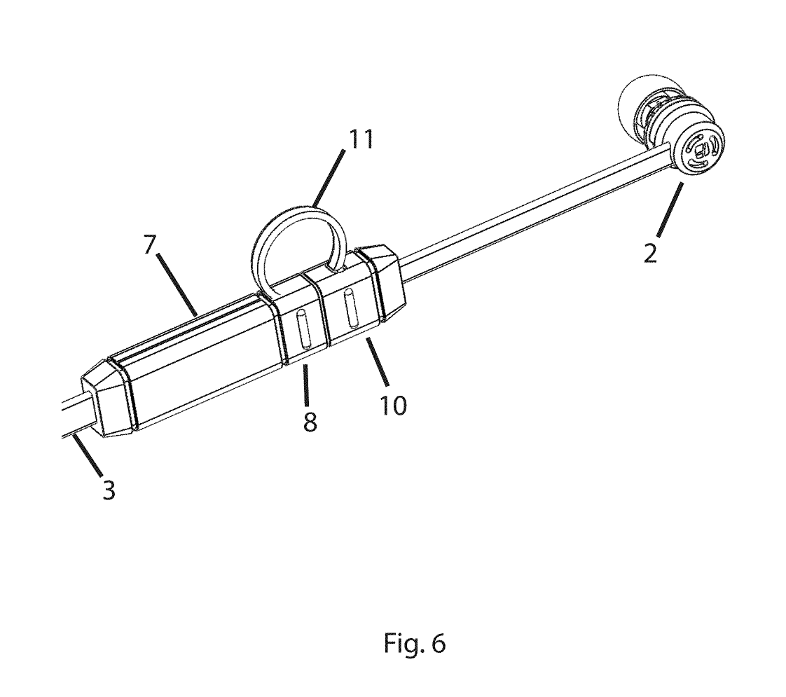

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

The Bluetooth headphone with charging and analog pass through connector is a rechargeable wireless headphone with an integrated charging and analog pass through connector. In the preferred embodiment, the rechargeable wireless headphone comprises of a pair of earphones 1, 2 connected to each other by a cable 3. The cable 3 incorporates a microphone 4, a power/sync button 5, a wireless communication module 6, a rechargeable battery 7 in a battery housing, and a USB Type-C connector 8 for charging the rechargeable battery 7 and also functions as an analog pass through connector. In the preferred embodiment, the microphone 4, the power/sync button 5, and the wireless communication module 6 are incorporated into a single unitary housing and the rechargeable battery 7 and the USB Type-C connector 8 are incorporated into a separate housing. An optional cable restrictor 9 may be incorporated between the two earphones 1, 2 to shorten the length of the cable 3 between the two earphones 1, 2. The cable restrictor 9 may be an elastic or non-elastic loop that is placed slidably over the cable 3 and slidable along the cable 3 to change the cable length between the two earphones 1, 2. In the preferred embodiment the rechargeable wireless headphone use a Bluetooth module as the wireless communication module 6 which uses the Bluetooth communication standard to communication with the audio signal source. However, other alternative wireless communication module that uses different wireless communication protocols and methods, such as radio frequency, may also be utilized.

In the preferred embodiment, the microphone 4, power/sync button 5, wireless communication module 6, rechargeable battery 7 in a battery housing, and the USB Type-C connector 8 are connected on the same section of the cable 3 with an earphone 1. The other earphone 2 is connected to another section of the cable 3 with a female USB Type-C port 10 to receive the USB Type-C connector 8 from the other section of the cable 3, forming a continuous length of cable 3 from one earphone 1 to the other earphone 2. The two sections of the cable 3 are further connected with a short section of flexible material 11 to enable the separation of the USB Type-C connector 8 from the female USB Type-C port 10 yet prevent the two sections of the cable 3 from complete separation from each other, thereby preventing misplacement of either section of the cable 3.

When the USB Type-C connector 8 is connected to the female USB Type-C port 10, it is functioning as an analog pass through connector from one earphone to the other. When recharging of the rechargeable battery 7 is desired, the USB Type-C connector 8 is disconnected from the female USB Type-C port 10, exposing the USB Type-C connector 8. The USB Type-C connector 8 may then be used to connect to any external standard USB Type-C port, which may be found on computers and other common charging devices, to recharge the rechargeable battery 7. After recharging is completed, the USB Type-C connector 8 may be disconnected from the external USB Type-C charging port and reconnect with the female USB Type-C port 10 on the other section of the cable 3 thereby reconnecting the two earphones 1, 2, acting as a analog pass through connector.

The rechargeable wireless headphone eliminated the need for any additional cable and/or charging accessories to recharge its rechargeable battery 7. It has a single compact and integrated charging and analog pass through connector that can connect directly to any standard female USB Type-C port for recharging which eliminates the need for a separate additional cable and/or charging accessories for recharging its rechargeable battery 7.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A Bluetooth headphone with charging and analog pass through connector comprising:
a first earphone connected with a first end of a first cable, wherein a second end of said first cable is connected to a male connector, and
a second earphone connected with a first end of a second cable, wherein a second end of said second cable is connected to a female port,
wherein said male connector is insertable into said female port to function as a pass through connector, and wherein said male connector is separable from said female port to function as a charging connector.

2. A Bluetooth headphone with charging and analog pass through connector as in claim 1, further including a microphone, a power/sync button, a wireless communication module, and a rechargeable battery disposed along said first and second cables.

3. A Bluetooth headphone with charging and analog pass through connector as in claim 1, wherein said male connector is a USB Type-C connector.

4. A Bluetooth headphone with charging and analog pass through connector as in claim 1, wherein said female port is a USB Type-C port.

5. A Bluetooth headphone with charging and analog pass through connector as in claim 2, wherein said male connector is a USB Type-C connector and wherein said female port is a USB Type-C port.

6. A Bluetooth headphone with charging and analog pass through connector as in claim 2, wherein said wireless communication module is a Bluetooth module.

7. A Bluetooth headphone with charging and analog pass through connector as in claim 6, wherein said microphone, said power/sync button, and said Bluetooth module are incorporated into a single unitary housing.

8. A Bluetooth headphone with charging and analog pass through connector as in claim 7, wherein said rechargeable battery and said male connector are incorporated into a second housing.

9. A Bluetooth headphone with charging and analog pass through connector as in claim 1, wherein a cable restrictor is slidably mounted on said first or second cable to enable adjustment of the length of said first or second cable between the first and second earphones.

10. A Bluetooth headphone with charging and analog pass through connector as in claim 1, wherein said first cable and said second cable are connected with a short section of flexible material.

11. A Bluetooth headphone with charging and analog pass through connector comprising:
a first earphone connected with a first end of a first cable, wherein a second end of said first cable is connected to a male connector, said first cable further includes a microphone, a power/sync button, a wireless communication module, and a rechargeable battery disposed between the first earphone and the male connector, and
a second earphone connected with a first end of a second cable, wherein a second end of said second cable is connected to a female port,
wherein said male connector is insertable into said female port to function as a pass through connector, and wherein said male connector is separable from said female port to function as a charging connector.

12. A Bluetooth headphone with charging and analog pass through connector as in claim 11, wherein said microphone, said power/sync button, and said wireless communication module are incorporated into a single unitary housing.

13. A Bluetooth headphone with charging and analog pass through connector as in claim 11, wherein said rechargeable battery and said male connector are incorporated into a separate housing.

14. A Bluetooth headphone with charging and analog pass through connector as in claim 11, wherein said male connector is a USB Type-C connector and wherein said female port is a USB Type-C port.

15. A Bluetooth headphone with charging and analog pass through connector as in claim 11, wherein said wireless communication module is a Bluetooth module.

16. A Bluetooth headphone with charging and analog pass through connector as in claim 11, wherein a cable restrictor is slidably mounted on said first or second cable to enable adjustment of the length of said first or second cable between the first and second earphones.

17. A Bluetooth headphone with charging and analog pass through connector as in claim 11, wherein said first cable and said second cable are connected with a short section of flexible material.

18. A Bluetooth headphone with charging and analog pass through connector comprising:
a first earphone connected with a first end of a first cable, wherein a second end of said first cable is connected to a USB Type-C connector, said first cable further includes a microphone, a power/sync button, and a Bluetooth module, all incorporated into a single unitary housing and a rechargeable battery in a separate battery housing all disposed along said first cable between the first earphone and the USB Type-C connector, and
a second earphone connected with a first end of a second cable, wherein a second end of said second cable is connected to a USB Type-C port,
wherein said USB Type-C connector is insertable into said USB Type-C port to function as a pass through connector, and wherein said USB Type-C connector is separable from said USB Type-C port to function as a charging connector.

19. A Bluetooth headphone with charging and analog pass through connector as in claim 18, wherein said first cable and said second cable are connected with a short section of flexible material.

20. A Bluetooth headphone with charging and analog pass through connector as in claim 18, wherein a cable restrictor is slidably mounted on said first or second cable to enable adjustment of the length of said first or second cable between the first and second earphones.
